(19) United States
(12) Patent Application Publication
(10) Pub. No.: US 2025/0163221 A1
(43) Pub. Date: May 22, 2025

(54) SULFONATED POLYARYLENESULFONE POLYMER (SP) HAVING AN AT LEAST BIMODAL MOLECULAR WEIGHT DISTRIBUTION

(71) Applicant: BASF SE, Ludwigshafen am Rhein (DE)

(72) Inventors: Martin WEBER, Ludwigshafen am Rhein (DE); Daniel MALKO, Ludwigshafen am Rhein (DE); Joachim STRAUCH, Ludwigshafen am Rhein (DE)

(21) Appl. No.: 18/841,800

(22) PCT Filed: Feb. 23, 2023
(86) PCT No.: PCT/EP2023/054580

§ 371 Date: Aug. 27, 2024

(30) Foreign Application Priority Data
Feb. 28, 2022 (EP) 22159256.1

(51) Int. Cl. C08G 75/23; C08J 5/22

(52) U.S. Cl. CPC C08G 75/23; C08J 5/2256; C08J 2381/06

(57) ABSTRACT

The present invention relates a sulfonated polyarylenesulfone polymer (sP) having an at least bimodal molecular weight distribution, a process for the preparation of the sulfonated polyarylenesulfone polymer (sP), a membrane (M) comprising the sulfonated polyarylenesulfone polymer (sP), a process for the preparation of the membrane (M), and the membrane (M) obtained by said process.

The present invention relates a sulfonated polyarylenesulfone polymer (sP) having an at least bimodal molecular weight distribution, a process for the preparation of the sulfonated polyarylenesulfone polymer (sP), a membrane (M) comprising the sulfonated polyarylenesulfone polymer (sP), a process for the preparation of the membrane (M), and the membrane (M) obtained by said process.

Politics, society and industry aim to reduce the CO₂-emissions by decarbonizing industry and mobility. In this context, green hydrogen plays a strategic role as it can substitute hydrocarbons for chemical and industrial processes, energy transformation and fuel cell propulsion in mobility applications. Renewable electrical power can be used to operate electrolysis cells to produce green, sustainable hydrogen.

A key component in electrolysis cells and electrodialysis cells are the so called polymer electrolyte membranes (PEM), which have to fulfil several requirements. They need to be ion conductive and at the same time separate the gases hydrogen and oxygen. In addition, membranes have to be robust and stable for a long operation and life-time with constant performance.

The state-of-the-art membranes are mainly based on fluorinated polymers with sulfonic acid side chains (PFSA's), which are known e. g. under the trade name Nafion®. Due to the complexity of the PFSA production, these polymers are still quite expensive. Furthermore, the toxicity and persistency of fluorinated chemicals raise several challenges for the production, use and recycling of these materials. Thus, science and industry try to develop more sustainable solutions to replace PFSA membranes.

One promising class of materials for these applications are polyarylenesulfone polymers. They belong to the group of high performance polymers having high heat resistance, chemical resistance, excellent mechanical properties and durability (E. M. Koch, H.-M. Walter, Kunststoffe 80 (1990) 1146; E. Döring, Kunststoffe 80, (1990) 1149, N. Inchaurondo-Nehm, Kunststoffe 98, (2008) 190).

Besides the use as engineering plastics, polyarylenesulfone polymers are also used as membrane material for water treatment (U.S. Pat. No. 9,199,205).

Polyarylenesulfone polymers can be formed inter alia either via the hydroxide method, wherein a salt is first formed from the dihydroxy component and the hydroxide, or via the carbonate method.

General information regarding the formation of polyarylenesulfone polymers by the hydroxide method is found inter alia in R. N. Johnson et. al., J. Polym. Sci. A-1 5 (1967) 2375, while the carbonate method is described in J. E. McGrath et. al., Polymer 25 (1984) 1827.

Methods of forming polyarylenesulfone polymers from aromatic bishalogen compounds and aromatic bisphenols or salts thereof in an aprotic solvent in the presence of one or more alkali metal or ammonium carbonates or bicarbonates are known to a person skilled in the art and are described in EP-A 297 363 and EP-A 135 130, for example.

High-performance thermoplastics such as polyarylenesulfone polymers are formed by polycondensation reactions which are typically carried out at a high reaction temperature in polar aprotic solvents, for example DMF (dimethylformamide), DMAc (dimethylacetamide), sulfolane, DMSO (dimethylsulfoxide) and NMP (N-methylpyrrolidone).

For the use as membrane materials in water electrolysis, electrodialysis or fuel cells, the polymer has to show ion conductivity, which can be achieved by functionalization of polyarylenesulfone polymers with sulfonic acid groups.

Sulfonated polyarylenesulfone polymers are known since decades. While the direct sulfonation of polyarylenesulfone polymers is leading to side reactions and allows only limited control on the degree of sulfonation, the use of the di-sulfonated aromatic dihalogensulfones, like sulfonated dichlorodiphenylsulfone (sDCDPS) as co-monomer allows the synthesis of well-defined sulfonated polyarylenesulfone polymers.

Although sulfonated polyarylenesulfone polymers show several interesting properties for the use as ion conducting membranes in fuel cells, electrodialysis cells or for electrolysis, a major issue which still has to be solved is the production process itself. One challenge is the extremely long reaction time and the work-up and isolation of such copolymers on large scale, particularly if high amounts of di-sulfonated monomers are used. The condensation leads to polymer suspensions containing the sulfonated copolymer (sulfonated polyarylenesulfone polymer) and salts. After separation of the salts, usually precipitation in isopropanol is done to isolate the sulfonated polyarylenesulfone polymers, which causes huge volumes of solvent mixtures that have to be re-worked or disposed. Furthermore, a part of the product is not completely precipitated and may lead to clogging of filters during subsequent separation. Moreover, for production of the membranes, the sulfonated copolymers have to be dissolved again.

It is therefore an object of the present invention to provide a sulfonated polyarylenesulfone polymer (sP) and a process for the preparation of said sulfonated polyarylenesulfone polymer (sP) which does not retain the disadvantages of the prior art or only in diminished form. The process should be easy to carry out. The sulfonated polyarylenesulfone polymer (sP) should be suitable for the manufacturing of membranes, especially membranes that are capable to separate hydrogen from hydrogen containing gas mixtures.

This object is achieved by a sulfonated polyarylenesulfone polymer (sP) having an at least bimodal molecular weight distribution with at least one first peak (P1) and at least one second peak (P2), wherein the maximum of the first peak (P1) has a relative molecular mass in the range of 800 to 5 000 g/mol and the maximum of the second peak (P2) has a relative molecular mass in the range of 8 000 to 300 000 g/mol, wherein the relative molecular mass is determined by gel permeation chromatography using dimethylacetamide as solvent and narrowly distributed poly(methyl methacrylate) as standard.

It has surprisingly been found, that the sulfonated polyarylenesulfone polymer (sP) having an at least bimodal molecular weight distribution is suitable for the preparation of membranes (M). Membranes (M) containing the sulfonated polyarylenesulfone polymer (sP) having an at least bimodal molecular weight distribution show an improved conductivity compared to membranes (M) comprising sulfonated polyarylenesulfone polymer having a monomodal molecular weight distribution.

The present invention will be described in more detail hereinafter.

### Sulfonated Polyarylenesulfone Polymer (sP)

The sulfonated polyarylenesulfone polymer (sP) according to in invention has an at least bimodal molecular weight distribution.

In the context of the present invention, the term “at least bimodal molecular weight distribution” means that the molecular weight distribution within the sulfonated polyarylenesulfone polymer (sP) according to the present invention may be bimodal, trimodal, tetramodal or pentamodal, or it may contain an even higher modality. In a preferred embodiment the sulfonated polyarylenesulfone polymer (sP), however, is bimodal.

The modality of the molecular weight distribution of the sulfonated polyarylenesulfone polymer (sP) according to the present invention is determined by the number of peaks in the GPC-diagram.

Unless indicated otherwise, the peaks are determined in the gel permeation chromatography (GPC) diagrams of the respective sulfonated polyarylenesulfone polymer (sP). The GPC-measurements are done using dimethylacetamide (DMAc) as solvent and narrowly distributed poly (methyl) methacrylate (PMMA) as standard. Preferably for GPC, the polymer (the sulfonated polyarylenesulfone polymer (sP)) is dissolved in DMAc at a concentration of 4 mg/ml, the solution is then filtered by using a 0.2 μm filter. 100 μl of this solution are injected into the system. The flow rate is usually set to 1 ml/min and 4 columns, which are kept at a temperature of 40° C., are used for the separation. As detector an RI-detector is used. The calibration of the system is done from 800 to 2200200 g/mol. The solvent used might also contain small amounts of salts, preferably LiBr.

Only those peaks are considered for determination of the respective modality, which contribute to an amount of more than 0.3 area-%, preferably of more than 0.4 area-%, to the total area of peaks in the GPC-diagram. In the context of the present invention, the term “GPC-diagram” means the diagram obtained by GPC showing the intensity of the peaks on the y-axis over the relative molecular mass on the x-axis.

In other words, rather small peaks in the baseline having a very low signal to noise ratio are not considered as a peak when determining the modality of the respective polymer.

In the context of the present invention, the term “relative molecular mass” means the molecular weights of the sulfonated polyarylenesulfone polymer (sP) determined by GPC set into relation with the molecular weights of the narrowly distributed poly (methyl) methacrylate standard with known molecular weights.

The sulfonated polyarylenesulfone polymer (sP) generally has an at least bimodal molecular weight distribution with at least one first peak (P1) and at least one second peak (P2).

The relative mass of the first peak (P1) is lower than the relative mass of the second peak (P2).

The maximum of the first peak (P1) has a relative molecular mass in the range of 800 to 5 000 g/mol, preferably in the range of 1000 to 4500 g/mol and more preferably in the range of 1250 to 4000 g/mol, wherein the relative molecular mass is determined by gel permeation chromatography using dimethylacetamide as solvent and narrowly distributed poly (methyl methacrylate) as standard as standard as described above.

The maximum of the second peak (P2) has a relative molecular mass in the range of 8 000 to 300 000 g/mol, preferably in the range of 9000 to 275000 g/mol and more preferably in the range of 10000 to 270000 g/mol, wherein the relative molecular mass is determined by gel permeation chromatography using dimethylacetamide as solvent and narrowly distributed poly (methyl methacrylate) as standard as described above.

For the determination of the relative molecular mass of the maximum of the peaks (P1 and P2) a perpendicular is dropped from each maximum to the x-axis of the GPC-diagram.

The maximum of the first peak (P1) preferably shows a lower intensity than the second peak (P2).

The ratio of the first intensity (I1 ) to the second intensity (I2) is generally in the range of 1:8 to 1:100, preferably in the range of 1:8 to 1:50 and more preferably in the range of 1:8 to 1:40.

The term intensity at present is understood preferably to mean the height of the maximum of a peak in the GPC-diagram.

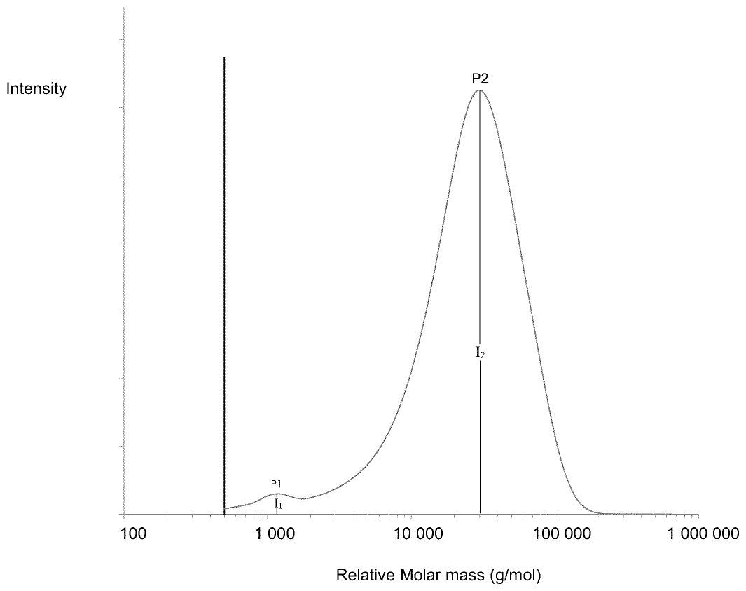

FIG. 1 shows a preferred embodiment of a GPC-diagram of a sulfonated polyarylenesulfone polymer (sP) having a bimodal molecular weight distribution. The intensity is shown on the y-axis. The relative molecular mass is shown on the x-axis. The maximum of the first peak (P1) is at a lower relative molecular weight than the maximum of the second peak (P2). In order to determine the relative molecular weight of the maximum of the first peak (P1) a perpendicular (denoted as I1 in FIG. 1) line (denoted as I1 in FIG. 1) is dropped form the maximum of the first peak (P1) to the x-axis. The relative molecular weight of maximum of the second peak is determined accordingly.

For the determination of the intensity of the maximum of the peaks (P1) and (P2) the height of the peaks is measured.

Another object of the present invention, therefore is a sulfonated polyarylenesulfone polymer (sP), wherein the maximum of the first peak (P1) shows a first intensity (I1) and the maximum of the second peak (P2) shows a second intensity (I2), wherein the ratio of the first intensity (I1) to the second intensity (I2) is in the range of 1:10 to 1:1000.

The sulfonated polyarylenesulfone polymer (sP) generally has a weight average molecular weight (Mw) in the range of 20 000 to 250 000 g/mol, preferably in the range of 30 000 to 225 000 g/mol and more preferably in the range of 40 000 to 200 000 g/mol, wherein the weight average molecular weight (M_{w}) is determined by gel permeation chromatography using dimethylacetamide as solvent and narrowly distributed 40 poly(methyl methacrylate) as standard as described above.

Another object of the present invention, therefore is a sulfonated polyarylenesulfone polymer (sP), wherein the sulfonated polyarylenesulfone polymer (sP) has a weight average molecular weight (Mw) in the range of 20 000 to 250 000 g/mol, wherein the weight average molecular weight (Mw) is determined by gel permeation chromatography using dimethylacetamide as solvent and narrowly distributed poly (methyl methacrylate) as standard.

In a preferred embodiment the sulfonated polyarylenesulfone polymer (sP) comprises from 15 to 80 mol-%, preferably in the range of 20 to 70 mol-%, and more preferably in the range of 25 to 65 mol-% of sulfonated recurring units comprising at least one-SO₃X³ group, based on the total amount of the sulfontated polyarylenesulfone polymer (sP), wherein X³ is hydrogen or one cation equivalent.

Recurring unit preferably is understood to mean the unit derived from a one aromatic dihalogensulfone and one aromatic dihydroxy compound; for example a recurring unit may be derived from one 4,4′-dihydroxybiphenyl and one 4,4′-dichlorodiphenylsulfone leading to a non-sulfonated recurring unit or a recurring unit may be derived from one 4,4′-dihydroxybiphenyl and one 4,4′-dichlorodiphenylsulfone-3,3′-disulfonic acid leading to a sulfonated recurring unit.

The term recurring unit is known by the person skilled in the art and is also called repeat unit or repeating unit.

Another object of the present invention, therefore is a sulfonated polyarylenesulfone polymer (sP), wherein the sulfonated polyarylenesulfone polymer (sP) comprises from 15 to 80 mol-% of sulfonated recurring units comprising at least one —SO₃X³ group, based on the total amount of the sulfontated polyarylenesulfone polymer (sP), wherein X³ is hydrogen or one cation equivalent.

Preferred sulfonated polyarylenesulfone polymers (sP) comprise sulfonated recurring units of the general formula I:

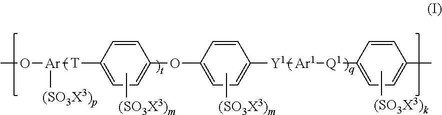

where
t and q: are each independently 0, 1, 2 or 3,
Q¹, T and Y¹: are each independently a chemical bond or selected from —O—, —S—, —SO₂—, —S(═O)—, —C ═O)—, —N═N—, and —CR^{a}R^{b}—,
   wherein R^{a} and R^{b} are each independently a hydrogen atom or a C₁-C₁₂-alkyl, C₁-C₁₂-alkoxy or C₆-C₁₈-aryl group, and wherein at least one of Q, T and Y is —SO₂—,
Ar and Ar¹: are each independently C₆-C₁₈ aryl, wherein said C₆-C₁₈ aryl is unsubstituted or substituted with at least one substituent selected from C₁-C₁₂ alkyl, C₁-C₁₂ alkoxy, C₆-C₁₈ aryl, halogen and —SO₃X,
p, m, n, and k: are each independently 0, 1, 2, 3 or 4, with the proviso that the sum total of p, m, n and k is not less than 1, and
X³: is hydrogen or one cation equivalent.

Another object of the present invention therefore is a sulfonated polyarylenesulfone polymer (sP), wherein the sulfonated polyarylenesulfone polymer (SP) comprises repeating units of the general formula (I):

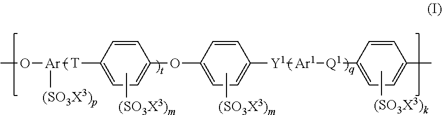

where
t and q: are each independently 0, 1, 2 or 3,
Q¹, T and Y¹: are each independently a chemical bond or selected from —O—, —S—, —SO₂—, —S(═O)—, —C(═O)—, —N═N—, and —CR^{a}R^{b}—,
   wherein R^{a} and R^{b} are each independently a hydrogen atom or a C₁-C₁₂-alkyl, C₁-C₁₂-alkoxy or C₆-C₁₈-aryl group, and wherein at least one of Q, T and Y is —SO₂—,
Ar and Ar¹: are each independently C₆-C₁₈ aryl, wherein said C₆-C₁₈ aryl is unsubstituted or substituted with at least one substituent selected from C₁-C₁₂ alkyl, C₁-C₁₂ alkoxy, C₆-C₁₈ aryl, halogen and —SO₃X,
p, m, n, and k: are each independently 0, 1, 2, 3 or 4, with the proviso that the sum total of p, m, n and k is not less than 1, and
X³: is hydrogen or one cation equivalent.

In a preferred embodiment the sulfonated polyarylenesulfone polymers (sP) comprises at least 80 wt % of repeating units of the general formula (I) based on the total weight of the sulfonated polyarylenesulfone polymers (sP).

If Q¹, T, or Y¹, with the abovementioned preconditions, is a chemical bond, this means that the adjacent group on the left-hand side and the adjacent group on the right-hand side have direct linkage to one another by way of a chemical bond.

R^{a} and R^{b} are each independently hydrogen or C₁-C₁₂ alkyl.

Preferred C₁-C₁₂ alkyl groups include linear and branched, saturated alkyl groups of 1 to 12 carbon atoms. The following moieties are suitable in particular: C₁-C₆ alkyl, such as methyl, ethyl, n-propyl, i-propyl, n-butyl, sec-butyl, 2- or 3-methylpentyl or comparatively long-chain moieties such as unbranched heptyl, octyl, nonyl, decyl, undecyl, lauryl, and the branched analogs thereof.

Alkyl moieties in the C₁-C₁₂ alkoxy groups used include the above-defined alkyl groups of 1 to 12 carbon atoms. Preferably used cycloalkyl moieties include in particular C₃-C₁₂ cycloalkyl moieties, e.g., cyclopropyl, cyclobutyl, cyclopentyl, cyclohexyl, cycloheptyl, cyclooctyl, cyclopropylmethyl, cyclopropylethyl, cyclopropylpropyl, cyclobutylmethyl, cyclobutylethyl, cyclopentylethyl, -propyl, -butyl, -pentyl, -hexyl, -cyclohexylmethyl, -dimethyl, -trimethyl.

Ar and Ar¹ are each independently C₆-C₁₈ aryl. Proceeding from the starting materials hereinbelow, Ar preferably derives from an electron-rich aromatic substance very susceptible to electrophilic attack, preferably selected from the group consisting of sulfonated or unsulfonated hydroquinone, resorcinol, dihydroxynaphthalene, in particular 2,7-dihydroxynaphthalene. . . . Ar1 is preferably an unsubstituted C₆ or C₁₂ arylene group.

Ar and Ar¹ in the preferred embodiment of formula (I) are each preferably selected independently from sulfonated or unsulfonated 1,4-phenylene, 1,3-phenylene, naphthylene, in particular 2,7-dihydroxynaphthalene.

Preferred are sulfonated polyarylenesulfone polymers (SP) having one or more of the following structural units (Ia) to (Io):

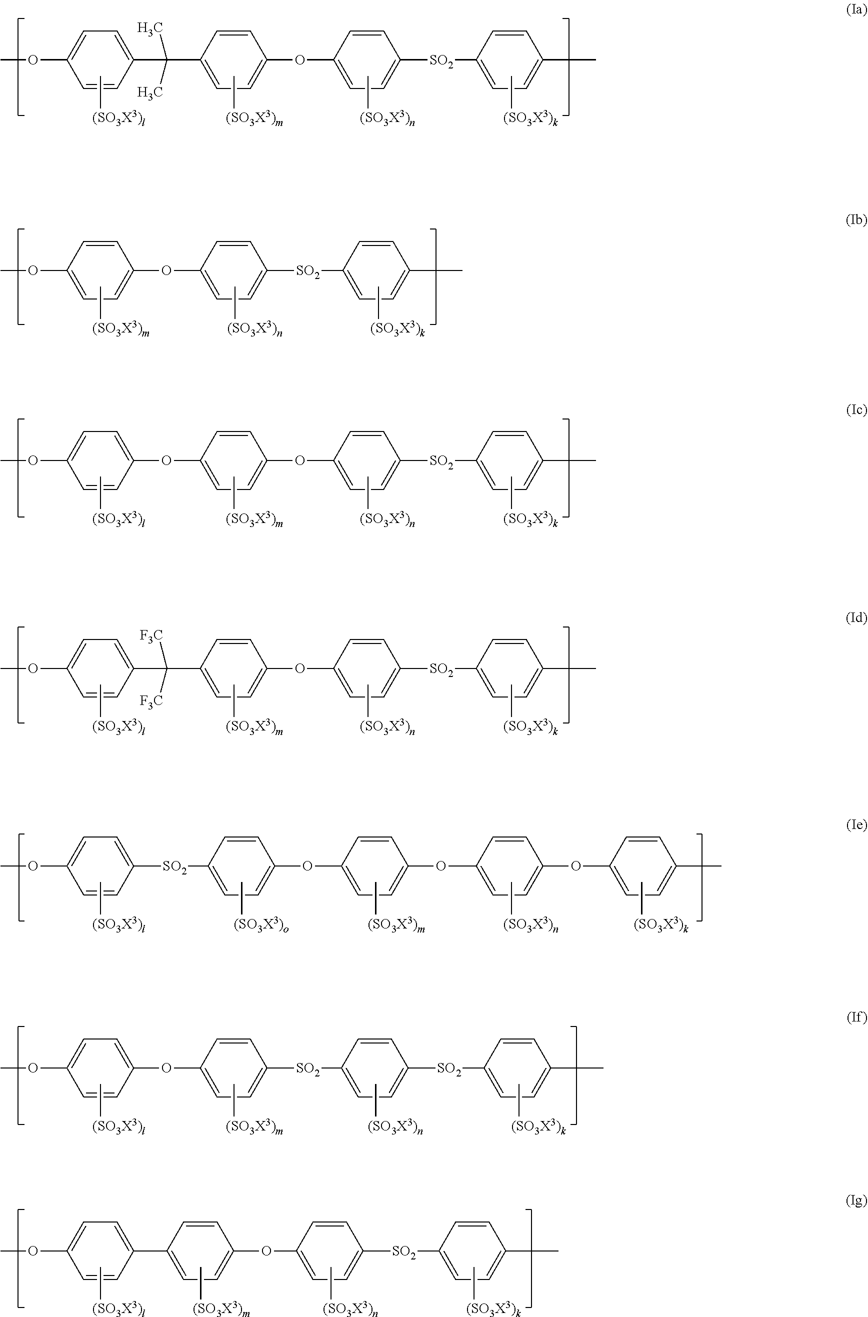

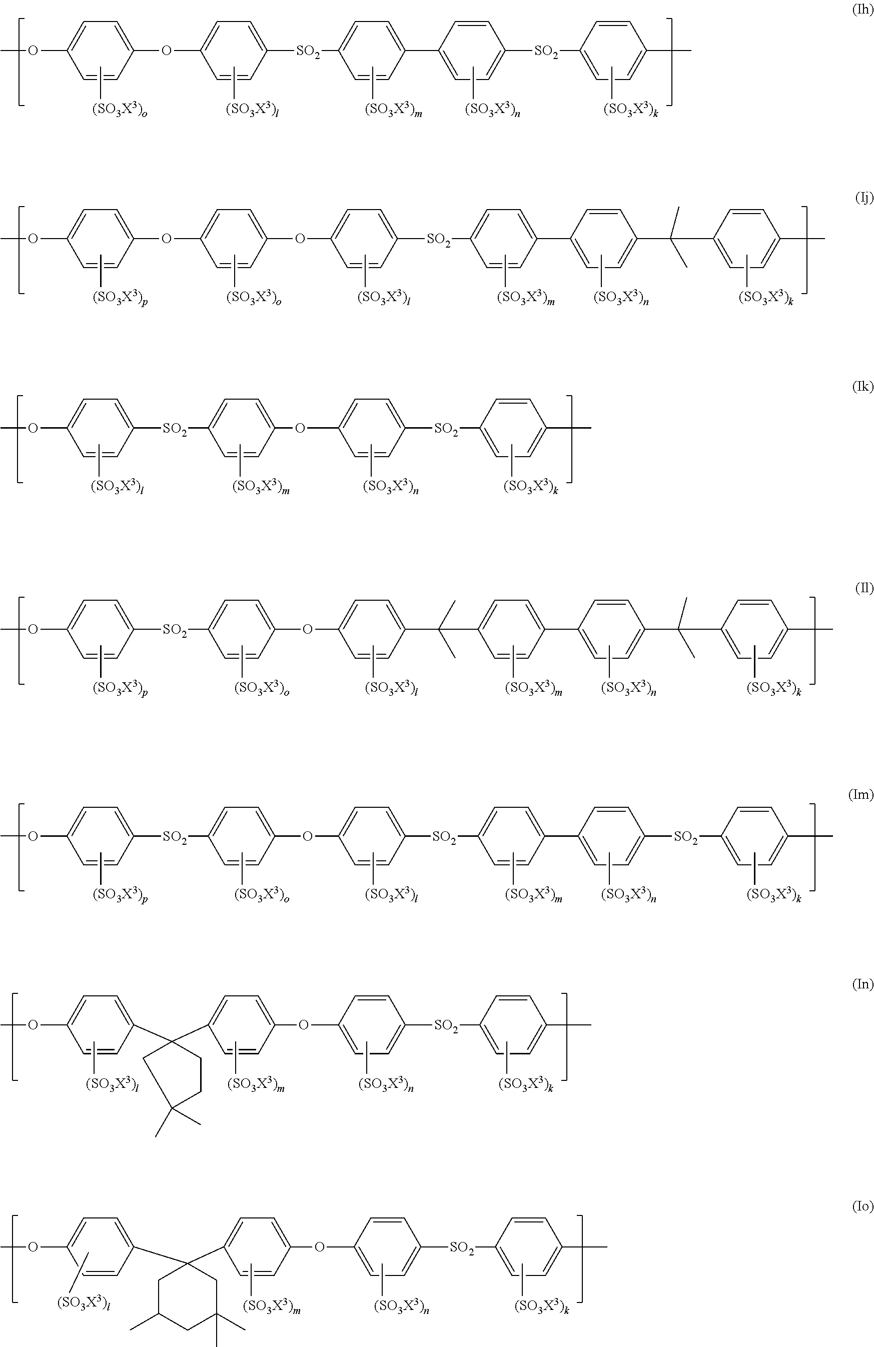

where
I, k, m, n, o, p are each independently 0, 1, 2, 3 or 4 subject to the proviso that the sum total of I, k, m, n, o and p is ≥1, and
X³ is hydrogen or one cation equivalent.

By “one cation equivalent” in the context of the present invention is meant one cation of a single positive charge or one charge equivalent of a cation with two or more positive charges, for example Li, Na, K, Mg, Ca, NH4, preferably Na, K.

In addition to the preferred building blocks (Ia) to (Io), preference is also given to those structural units in which one or more sulfonated or unsulfonated 1,4-dihydroxyphenyl units are replaced by resorcinol or dihydroxynaphthalene.

Copolymers constructed of the various structural units in combination or of sulfonated and non-sulfonated structural units are also usable.

Structural units (Ia), (Ib), (Ig) and (Ik) or copolymers thereof are used with particular preference as repeat unit of general formula (I).

In one particularly preferred embodiment, Ar is 1,4-phenylene, t is 1, T is a chemical bond, Y¹ is —SO₂—, q is 0, p is 0, m is 0, n is 1 and k is 1. Sulfonated polyphenylenesulfones constructed of this recited structural repeat unit are denoted sPPSU.

In a particularly preferred embodiment, Ar is 1,4-phenylene, t is 0, Y is —SO₂—, q is 0, n is 0 and k is 0. Polyarylenesulfones constructed of this recited structural repeat unit are denoted sulfonated polyether ether sulfones (sPESU).

In one advantageous embodiment, the sulfonated polyarylenesulfone polymer (sP) comprises
a nonsulfonated recurring unit of formula (1)

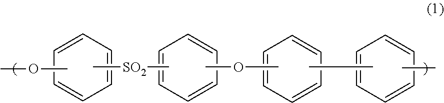

and a sulfonated recurring unit of formula (2)

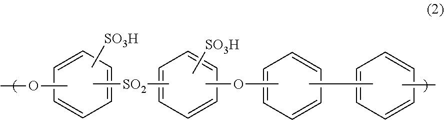

In particular, the sulfonated polyarylenesulfone polymer (SP) consists exclusively of non-sulfonated repeating units of formula (1) and sulfonated repeat units of formula (2).

In a very advantageous embodiment, the sulfonated polyarylenesulfone polymer (SP) comprises a nonsulfonated recurring unit of formula (1a)

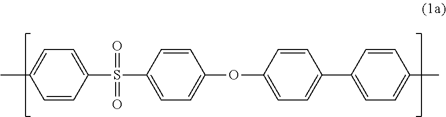

and a sulfonated recurring unit of formula (2a)

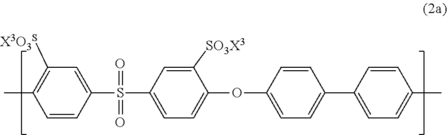

In particular, the sulfonated polyarylenesulfone polymer (SP) consists exclusively of non-sulfonated repeat units of formula (1a) and sulfonated recurring units of formula (2a).

### Process

The sulfonated polyarylenesulfone polymer (sP) according to the invention is preferably prepared by converting a reaction mixture (R_{G}) comprising an aromatic dihalogensulfone component, at least one aromatic dihydroxy compound, and at least one carbonate compound. In a preferred embodiment the reaction mixture (R_{G}), moreover, comprises at least one aprotic polar solvent.

The aromatic dihalogensulfone component is also referred to as component (A). The terms aromatic dihalogensulfone component and component (A) in the present invention are used synonymously and therefore have the same meaning.

The at least one aromatic dihydroxy compound is also referred to as component (B). The terms at least one aromatic dihydroxy compound and component (B) in the present invention are used synonymously and therefore have the same meaning.

The at least one carbonate compound is also referred to as component (C). The terms at least one carbonate compound and component (C) in the present invention are used synonymously and therefore have the same meaning.

The at least one aprotic polar solvent is also referred to as component (D). The terms at least one aprotic polar solvent and component (D) in the present invention are used synonymously and therefore have the same meaning.

Another object of the present invention therefore is a process for the preparation of a sulfonated polyarylenesulfone polymer (sP) comprising the step i) of converting a reaction mixture (R_{G}) comprising as components
(A) an aromatic dihalogensulfone component comprising at least one sulfonated aromatic dihalogensulfone (component (A1)), and at least one non sulfonated aromatic dihalogensulfone (component (A2)),
(B) at least one aromatic dihydroxy compound, and
(C) at least on carbonate compound.

Another object of the present invention therefore is a process, wherein the reaction mixture (R_{G})), moreover, comprises at least one aprotic polar solvent (component (D)).

The reaction mixture (R_{G}) is the mixture which is provided for forming the sulfonated polyarylenesulfone polymer (sP). All components herein in relation to the reaction mixture (R_{G}) thus relate to the mixture which is present before the polycondensation. The polycondensation takes place to convert reaction mixture (R_{G}) into the target product, the sulfonated polyarylenesulfone polymer (sP), by polycondensation of components (A), and (B).

In step i) components (A) and (B) enter the polycondensation reaction. Component (C) acts as a base to deprotonate the hydroxyl groups of component (B). Component (D), if present, acts as a solvent.

The mixture obtained after the polycondensation which comprises the sulfonated polyarylenesulfone polymer (sP) target product is also referred to as product mixture (P_{G}). The product mixture (P_{G}) preferably furthermore comprises a halide compound and preferably the at least one aprotic polar solvent (component (D)). The halide compound is formed during the conversion of the reaction mixture (R_{G}). During the conversion first, component (C) reacts with component (B) to deprotonate component (B). Deprotonated component (B) then reacts with component (A) wherein the halide compound is formed.

This process is known to the person skilled in the art.

The components of the reaction mixture (R_{G}) are preferably reacted concurrently. The individual components may be mixed in an upstream step and subsequently be reacted. It is also possible to feed the individual components into a reactor in which these are mixed and then reacted.

In the process according to the invention, the individual components of the reaction mixture (R_{G}) are preferably reacted concurrently preferably in step i). This reaction is preferably conducted in one stage. This means, that the deprotonation of component (B) and also the condensation reaction between components (A) and (B) take place in a single reaction stage without isolation of the intermediate products, for example the deprotonated species of component (B).

It is furthermore preferred that the reaction mixture (R_{G}) does not comprise toluene or monochlorobenzene. It is particularly preferred that the reaction mixture (R_{G}) does not comprise any substance which forms an azeotrope with water.

The ratio of component (A) and component (B) derives in principle from the stoichiometry of the polycondensation reaction which proceeds with theoretical elimination of hydrogen chloride and is established by the person skilled in the art in a known manner.

Preferably, the ratio of halogen end groups derived from component (A) to phenolic end groups derived from component (B) is adjusted by controlled establishment of an excess of component (A) in relation to component (B) as starting compound.

Preferably, the conversion in the polycondensation reaction is at least 0.9.

Process step i) for the preparation of the sulfonated polyarylenesulfone polymer (sP) is preferably carried out under conditions of the so called “carbonate method”. This means that the reaction mixture (R_{G}) is reacted under the conditions of the so called “carbonate method”. The polycondensation reaction is generally conducted at temperatures in the range from 80 to 250° C., preferably in the range from 100 to 220° C. The upper limit of the temperature is preferably determined by the boiling point of the at least one aprotic polar solvent (component (D)) at standard pressure (1013.25 mbar). The reaction is generally carried out at standard pressure. The reaction is preferably carried out over a time interval of 0.5 to 14 h, particularly in the range from 1 to 12 h.

In a preferred embodiment in step i) a reaction mixture (R_{G}) is converted comprising
X mol of an aromatic dihalogensulfone component (component A)) comprising, based on the total molar amount of the aromatic dihalogensulfone component (component A)) in the reaction mixture (R_{G}),
X¹ mol.-% of at least one sulfonated aromatic dihalogensulfone (component (A1)), and
X² mol.-% of at least one non sulfonated aromatic dihalogensulfone (component (A²)), wherein

X¹ is in the range of 15 to 80 and
X² is in the range of 20 to 85,

Y mol of at least one aromatic dihydroxy compound (component (B))
Z mol of at least one carbonate compound (component (C)),
wherein
the ratio of X to Y is in the range of 0.95 to 1.05,
and wherein
Z is in the range of P to Q,
wherein P is calculated according to the following equation:

$$P = Y * ( 1.05 + {X}^{1} / 100 * 1.05 ) ,$$

and wherein Q is calculated according to the following equation:

$$Q = Y * ( 1.05 + {X}^{1} / 100 * 1.4 ) .$$

More preferably, the molar ratio of component (A) to component (B) is from 0.95 to 1.05, especially from 0.96 to 1.04, most preferably from 0.97 to 1.03.

In a preferred embodiment the ratio of X to Y is from 0.95 to 1.05, especially from 0.96 to 1.04, most preferably from 0.97 to 1.03.

In a preferred embodiment the sulfonated polyarylenesulfone polymer (sP) obtained in step i) is not separated from the product mixture (P_{G}).

In a preferred embodiment the product mixture (P_{G}) obtained after step i) is further worked up by the steps ii) and iii) as described below.

In a preferred embodiment, therefore after step i) a product mixture (P_{G}) is obtained comprising the sulfonated polyarylenesulfone polymer (sP), the at least one aprotic polar solvent and at least one inorganic halide compound, and the process moreover comprises the steps of
ii) separating the at least one inorganic halide from the product mixture (P_{G}) to obtain a solution(S) comprising the sulfonated polyarylenesulfone polymer (sP) and the at least one aprotic polar solvent, and
iii) separating the at least one aprotic polar solvent from the solution(S) by evaporation to obtain the sulfonated polyarylenesulfone polymer (sP).

After step iii) the sulfonated polyarylenesulfone polymer (sP) may be further processed, for example by extraction with a solvent, preferably with a polar protic solvent like water.

In step ii) the inorganic halide compound formed in step i) during the condensation reaction is removed from the product mixture (P_{G}). To obtain a solution (S) comprising the sulfonated polyarylenesulfone polymer (SP) and the at least one aprotic polar solvent (component (D)).

The inorganic halide compound can be removed by measures commonly known in the art like filtration, centrifugation, decantation etc.

The present invention therefore also provides a process wherein the process comprises the step
ii) filtration, centrifugation and/or decantation of the product mixture (P_{G}) obtained in step i) to obtain the solution (S).

In a preferred embodiment the solution (S) obtained in step ii) comprises no solid inorganic halide compounds. In a further preferred embodiment the solution(S) obtained in step ii) comprises less than 3 wt %, more preferred less than 1.5 wt % and particularly preferred less than 0.5 wt % of inorganic halide components based on the total weight of the solution(S) obtained in step ii).

In a more preferred embodiment the solution(S) obtained in step ii) comprises no solid inorganic compounds.

In a further preferred embodiment the solution(S) obtained in step ii) comprises less than 0.4 wt %, more preferred less than 0.3 wt % and particularly preferred less than 0.2 wt % of inorganic components based on the total weight of the solution(S) obtained in step ii).

In a preferred embodiment the sulfonated polyarylenesulfone polymer (sP) in step ii) is not separated from the solution(S).

In a further preferred embodiment the sulfonated polyarylenesulfone polymer (sP) in the solution(S) in step ii) remains in dissolved form before step iii) is conducted.

In a particularly preferred embodiment the sulfonated polyarylenesulfone polymer (sP) in the inventive process remains dissolved until step iii) is carried out.

In a further particularly preferred embodiment the sulfonated polyarylenesulfone polymer (sP) is not separated before step iii) is carried out.

The components used in the inventive process for the preparation of the sulfonated polyarylenesulfone polymer (sP) are described hereinafter in more detail.

### Component (A)

Component (A), which is also referred to as the aromatic dihalogensulfone component, comprises at least one sulfonated aromatic dihalogensulfone and at least one non sulfonated aromatic dihalogensulfone.

The at least one sulfonated aromatic dihalogensulfone is also referred to as component (A1). The terms at least one sulfonated aromatic dihalogensulfone and component (A1) in the present invention are used synonymously and therefore have the same meaning.

The at least one non sulfonated aromatic dihalogensulfone is also referred to as component (A2). The terms at least one non sulfonated aromatic dihalogensulfone and component (A2) in the present invention are used synonymously and therefore have the same meaning.

What is meant herein by “at least one sulfonated aromatic dihalogensulfone” is precisely one sulfonated aromatic dihalogensulfone and also mixtures of two or more sulfonated aromatic dihalogensulfones. Preferably precisely one sulfonated aromatic dihalogensulfone is used.

What is meant herein by “at least one non sulfonated aromatic dihalogensulfone” is precisely one non sulfonated aromatic dihalogensulfone and also mixtures of two or more non sulfonated aromatic dihalogensulfones. Preferably precisely one non sulfonated aromatic dihalogensulfone is used.

“X” preferably means the amount of mol of component (A) in the reaction mixture (R_{G}). “X” herein preferably means the total molar amount of the aromatic dihalogensulfone component (component (A)) in the reaction mixture (R_{G}). In other words “X” means preferably the sum of the molar amount of component (A1) and component (A2) contained in component (A), preferably contained in the reaction mixture (R_{G}). “X¹” herein means the molar amount in mol.-% of component (A1) and “X²” herein means the molar amount in mol.-% of component (A2), based on the total molar amount of component (A) in the reaction mixture (R_{G}).

X¹ is for example in the range of 15 to 80 mol.-%, preferably in the range of 20 to 70 mol.-%, more preferably in the range of 25 to 65 mol.-%, and most preferably in the range of 27.5 to 62.5 mol.-%, in each case based on the total molar amount of the aromatic dihalogensulfone component (component (A)) in the reaction mixture (R_{G}).

X² is generally in the range of 20 to 85 mol.-%, preferably in the range of 30 to 80 mol.-%, more preferably in the range of 35 to 75 mol.-%, and most preferably in the range of 37.5 to 72.5 mol.-%, in each case based on the total molar amount of the aromatic dihalogensulfone component (component (A)) in the reaction mixture (R_{G}).

The amount of X¹ and X² generally adds up to 100 mol.-%.

### Component (A1)

Component (A1), which is also referred to as the sulfonated aromatic dihalogensulfone comprises preferably at least one —SO₃X³ group.

Component (A1) preferably comprises at least one —SO₃X³ group. What is meant herein by “at least one —SO₃X³ group” is that component (A1) can comprise precisely one —SO₃X³ group and also two or more —SO₃X³ groups. Component (A1) more preferably

The general formula —SO₃X³ comprises the sulfonic acid functional group and also derivatives of sulfonic acid functional groups such as sulfonates. In the —SO₃X³ group(s) X³ may be hydrogen and/or one cation equivalent.

By “one cation equivalent” in the context of the present invention is meant one cation of a single positive charge or one charge equivalent of a cation with two or more positive charges, for example Li, Na, K, Mg, Ca, NH4, preferably Na, K. Particularly preferred is Na or K.

Component (A1) is preferably selected from the group consisting of 4,4′-dichlorodiphenylsulfone-3,3′-disulfonic acid and 4,4′-difluorodiphenylsulfone-3,3′-disulfonic acid, and derivatives thereof.

The terms “sulfonic acid” and “—SO₃X³ group” in the context of the present invention are used synonymously and have the same meaning. The term “sulfonic acid” in the 4,4′-dichlorodiphenylsulfone-3,3′-disulfonic acid and 4,4′-difluorodiphenylsulfone-3,3′-disulfonic acid therefore means “—SO₃X³ group”, wherein X³ is hydrogen or a cation equivalent.

In one embodiment, component (A1) preferably comprises —SO₃X³ groups with a cation equivalent. Especially preferably, component (A1) is selected from the group consisting of 4,4′-dichlorodiphenylsulfone-3,3′-disulfonic acid, 4,4′-dichlorodiphenylsulfone-3,3′-disulfonic acid disodium salt, 4,4′-dichlorodiphenylsulfone-3,3′-disulfonic acid dipotassium salt, 4,4′-difluorodiphenylsulfone-3,3′-disulfonic acid, 4,4′-difluorodiphenylsulfone-3,3′-disulfonic acid disodium salt and 4,4′-difluorodiphenylsulfone-3,3′-disulfonic acid dipotassium salt.

Another object of the present invention therefore is a process, wherein component (A1) comprises at least one compound selected from the group consisting of 4,4′-dichlorodiphenylsulfone-3,3′-disulfonic acid, 4,4′-dichloro-diphenylsulfone-3,3′-disulfonic acid disodium salt, 4,4′-dichlorodiphenylsulfone-3,3′-disulfonic acid dipotassium salt, 4,4′-difluorodiphenylsulfone-3,3′-disulfonic acid, 4,4′-difluorodiphenylsulfone-3,3′-disulfonic acid disodium salt and 4,4′-difluorodiphenylsulfone-3,3′-disulfonic acid dipotassium salt.

In one embodiment, component (A1) comprises not less than 70 wt %, preferably not less than 90 wt %, and more preferably not less than 98 wt % of at least one aromatic dihalogensulfone component comprising at least one —SO₃X³ group selected from the group consisting of 4,4′-dichlorodiphenylsulfone-3,3′-disulfonic acid, 4,4′-dichlorodiphenylsulfone-3,3′-disulfonic acid disodium salt, 4,4′-dichlorodiphenylsulfone-3,3′-disulfonic acid dipotassium salt, 4,4′-difluorodiphenylsulfone-3,3′-disulfonic acid, 4,4′-difluorodiphenylsulfone-3,3′-disulfonic acid disodium salt and 4,4′-difluorodiphenylsulfone-3,3′-disulfonic acid dipotassium salt, based on the overall weight of component (A1) in the reaction mixture (R_{G}).

In a further particularly preferred embodiment, component (A1) consists essentially of at least one aromatic dihalogensulfone comprising at least one —SO₃X³ group selected from the group consisting of 4,4′-dichlorodiphenylsulfone-3,3′-disulfonic acid, 4,4′-dichlorodiphenylsulfone-3,3′-disulfonic acid disodium salt, 4,4′-dichlorodiphenylsulfone-3,3′-disulfonic acid dipotassium salt, 4,4′-difluorodiphenylsulfone-3,3′-disulfonic acid, 4,4′-difluorodiphenylsulfone-3,3′-disulfonic acid disodium salt and 4,4′-difluorodiphenylsulfone-3,3′-disulfonic acid dipotassium salt.

In these embodiments, 4,4′-dichlorodiphenylsulfone-3,3′-disulfonic acid dipotassium salt and 4,4′-dichlorodiphenylsulfone-3,3′-disulfonic acid disodium salt are particularly preferable for use as component (A1).

In a further, particularly preferred embodiment, component (A1), consists of 4,4′-dichlorodiphenylsulfone-3,3′-disulfonic acid dipotassium salt or 4,4′-dichloro-diphenylsulfone-3,3′-disulfonic acid disodium salt.

### Component (A2)

Component (A2), which is also referred to as the non sulfonated aromatic dihalogensulfone component comprises preferably no —SO₃X³ 3X3 groups.

Preferably, component (A2) comprises not less than 80 wt %, preferably not less than 90 wt %, and more preferably not less than 98 wt % of at least one aromatic dihalogensulfone selected from the group consisting of 4,4′-dichlorodiphenylsulfone and 4,4′-difluorodiphenylsulfone, based on the overall weight of component (A2) in reaction mixture (R_{G}). The weight percentages here in relation to component (A2) further relate to the sum total of the 4,4′-dichlorodiphenylsulfone used and of the 4,4′-difluoro-diphenylsulfone used.

Another object of the present invention therefore is a process, wherein component (A2) comprises not less than 80 wt % of at least one aromatic dihalogensulfone selected from the group consisting of 4,4′-dichlorodiphenylsulfone and 4,4′-difluorodiphenylsulfone, based on the overall weight of component (A2) in reaction mixture (R_{G}).

In a further particularly preferred embodiment, component (A2) consists essentially of at least one aromatic dihalogensulfone selected from the group consisting of 4,4′-dichloro-dipheny sulfone and 4,4′-difluorodiphenyl sulfone. In these embodiments, 4,4′-dichlorodiphenyl sulfone is particularly preferable for use as component (A2).

Preferably, component (A2) is selected from the group consisting of 4,4′-dichlorodiphenylsulfone and 4,4′-difluorodiphenylsulfone.

### Component (B)

Component (B), which is also referred to as the aromatic dihydroxy compound generally comprises two hydroxy groups.

What is meant herein by “at least one aromatic dihydroxy compound” is precisely one aromatic dihydroxy compound and also mixtures of two or more aromatic dihydroxy compounds. Preferably precisely one aromatic dihydroxy compound is used.

“Y” preferably means the amount of mol of component (B) in the reaction mixture (R_{G}). “Y” herein preferably means the total molar amount of the aromatic dihydroxy compound (component (B)) in the reaction mixture (R_{G}).

Preferably, component (B) is selected from the group consisting of 4,4′-dihydroxybiphenyl, 4,4′-dihydroxydiphenylsulfone, bisphenol A (2,2-bis (4-hydroxyphenyl)propane), 4,4′-dihydroxybenzophenone and hydroquinone. From among the aforementioned aromatic dihydroxy components, 4,4′-dihydroxybiphenyl, 4,4′-dihydroxydiphenyl sulfone and bisphenol A are preferable, while 4,4′-dihydroxybiphenyl is particularly preferable.

The present invention accordingly also provides a method wherein component (B) is selected from the group consisting of 4,4′-dihydroxybiphenyl, 4,4′-dihydroxydiphenyl sulfone, bisphenol A, 4,4′-dihydroxybenzophenone and hydroquinone.

Preferably, component (B) comprises not less than 80 wt %, preferably not less than 90 wt % and more preferably not less than 98 wt % of 4,4′-dihydroxybiphenyl, based on the overall weight of component (B) in reaction mixture (R_{G}).

Another object of the present invention therefore is a process, wherein component (B) comprises not less than 80 wt % 4,4′-dihydroxybiphenyl, based on the overall weight of component (B) in reaction mixture (R_{G}).

The weight percentages here in relation to component (B) further relate to the sum total of the 4,4′-dihydroxybiphenyl, 4,4′-dihydroxydiphenyl sulfone, bisphenol A (2,2-bis-(4-hydroxyphenyl) propane), 4,4′-dihydroxybenzophenone and hydroquinone used.

In a further particularly preferred embodiment, component (B) consists essentially of at least one aromatic dihydroxy component selected from the group consisting of 4,4′-dihydroxybiphenyl, 4,4′-dihydroxydiphenylsulfone, bisphenol A (2,2-bis (4-hydroxyphenyl) propane), 4,4′-dihydroxybenzophenone and hydroquinone. In these embodiments, 4,4′-dihydroxybiphenyl, bisphenol A and 4,4′-dihydroxydiphenylsulfone are particularly preferable for use as component (B), while 4,4′-dihydroxybiphenyl is most preferable.

### Component (C)

The reaction mixture (R_{G}) comprises at least one carbonate compound as component (C). The term “at least one carbonate compound” in the present case, is understood to mean exactly one carbonate compound and also mixtures of two or more carbonate compounds. The at least one carbonate compound is preferably at least one metal carbonate. The metal carbonate is preferably anhydrous. In the present case the terms “at least one carbonate compound” and “component (C)” are used synonymously and therefore have the same meaning.

Preference is given to alkali metal carbonates and/or alkaline earth metal carbonates as metal carbonates. At least one metal carbonate selected from the group consisting of sodium carbonate, potassium carbonate and calcium carbonate is particularly preferred as metal carbonate. Potassium carbonate is most preferred.

For example, component (C) comprises not less than 50 wt %, more preferred not less than 70 wt % by weight and most preferred not less than 90 wt % of potassium carbonate based on the total weight of the at least one carbonate component in the reaction mixture (R_{G}).

Another object of the present invention therefore is a process, wherein component (C) comprises not less than 50 wt % of potassium carbonate based on the total weight of component (C) in the reaction mixture (R_{G}).

In a preferred embodiment component (C) consists of potassium carbonate. Potassium carbonate having a volume weighted average particle size of less than 200 μm is preferred as potassium carbonate more preferred less than 100 μm more even more preferred less than 70 μm and most preferred less than 50 μm. The volume weighted average particle size of the potassium carbonate is determined in a suspension of potassium carbonate in a mixture chlorobenzene/sulfolane (60/40 by weight) using a particle size analyser.

“Z” preferably means the amount of mol of component (C) in the reaction mixture (R_{G}). “Z” herein means preferably the total molar amount of the at least one carbonate component (component (C)) in the reaction mixture (R_{G}).

Z is in the range of P to Q.

“P” is calculated according to the following equation:

$$P = Y * ( 1.05 + {X}^{1} / 100 * 1.05 )$$

In this equation Y is the value of the molar amount of component (B) in the reaction mixture (R_{G}) and X¹ is the value of the mol.-% of component (A1) in reaction mixture (R_{G}).

“Q” is calculated according to the following equation:

$$Q = Y * ( 1.05 + {X}^{1} / 100 * 1.4 )$$

In this equation Y is also the value of the molar amount of component (B) in the reaction mixture (R_{G}) and X¹ is also the value of the mol.-% of component (A1) in reaction mixture (R_{G}).

### Component (D)

The reaction mixture (R_{G}) comprises preferably at least one aprotic polar solvent as component (D). “At least one aprotic polar solvent”, according to the invention, is understood to mean exactly one aprotic polar solvent and also mixtures of two or more aprotic polar solvents. In the present case the terms “at least one aprotic polar solvent” and “component (D)” are used synonymously and therefore have the same meaning.

Suitable aprotic polar solvents are, for example, selected from the group consisting of anisole, dimethylformamide, dimethylsulfoxide, sulfolane, N-methylpyrrolidone, N-ethylpyrrolidone and N-dimethylacetamide.

Preferably, component (D) is selected from the group consisting of N-methylpyrrolidone, N-dimethylacetamide, dimethylsulfoxide and dimethylformamide. N-methylpyrrolidone is particularly preferred as component (D).

It is preferred that component (D) comprises not less than 50 wt %, preferably not less than 70 wt % and more preferably not less than 90 wt % of at least one solvent selected from the group consisting of N-methylpyrrolidone, N-dimethylacetamide, dimethylsulfoxide and dimethylformamide based on the total weight of component (D) in the reaction mixture (R_{G}). N-methylpyrrolidone is particularly preferred as component (D).

Another object of the present invention therefore is a process, wherein component (D) comprises not less than 50 wt % of at least one solvent selected from the group consisting of N-methylpyrrolidone, N-dimethylacetamide, dimethylsulfoxide and dimethylformamide based on the total weight of component (D) in the reaction mixture (R_{G}).

In a preferred embodiment, component (D) consists of N-methylpyrrolidone. N-methylpyrrolidone is also referred to as NMP or N-methyl-2-pyrrolidone.

### Membrane (M)

The inventive sulfonated polyarylenesulfone polymer (sP) is suitable for the preparation of membranes (M). The sulfonated polyarylenesulfone polymer (sP) according to the invention can be used in a membrane (M).

Another object of the present invention is therefore also the use of the sulfonated polyarylenesulfone polymer (sP) obtainable by the inventive process in a membrane (M).

The membrane (M) can be prepared from sulfonated polyarylenesulfone polymer (sP) according to the present invention by any method known to the skilled person.

Preferably, the membrane (M) comprising the sulfonated polyarylenesulfone polymer (sP) according to the invention is prepared by a method comprising the steps
i) providing a solution(S) which comprises the sulfonated polyarylenesulfone polymer (sP) and at least one solvent,
ii) separating the at least one solvent from the solution(S) to obtain the membrane (M).

Another object of the present invention is therefore aprocess for the preparation of a membrane (M) comprising the sulfonated polyarylenesulfone polymer (sP) obtained by the inventive process comprising the steps
i) providing a solution(S) which comprises the sulfonated polyarylenesulfone polymer (sP) obtained by the inventive process and at least one solvent,
ii) separating the at least one solvent from the solution(S) to obtain the membrane (M).

In a preferred embodiment the process for the preparation of a membrane (M) comprising the sulfonated polyarylenesulfone polymer (sP) according to any of claims 1 to 5 comprising the steps
ii-1) providing the solution(S) obtained in step ii) according to claim 9 comprising the sulfonated polyarylenesulfone polymer (sP) and the at least on aprotic polar solvent, and
iii-1) separating the at least one aprotic polar solvent from the solution(S) to obtain the membrane (M).

A further object of the present invention is a membrane (M) which comprises the sulfonated polyarylenesulfone polymer (sP).

Another object of the present invention is a membrane (M) comprising the sulfonated polyarylenesulfone polymer (sP) obtained by the inventive process.

The membrane (M) comprises preferably at least 50% by weight of the sulfonated polyarylenesulfone polymer (sP), more preferably at least 70% by weight and most preferably at least 90% by weight of the sulfonated polyarylenesulfone polymer (sP) based on the total weight of the membrane (M).

The membrane (M) is suitable for the separation of gases out of gas mixtures especially for the separation of hydrogen from hydrogen containing gas mixtures.

Another object of the present invention therefore is the use of the membrane (M) obtained by the inventive process for the separation of gas from gas mixtures

The present invention is more particularly elucidated by the following examples without being restricted thereto.

### Components Used:

DCDPS 4,4′-dichlorodiphenyl sulfone,
sDCDPS 4,4′-dichlorodiphenylsulfone-3,3′-disulfonic acid disodium salt
BP 4,4′-dihydroxybiphenyl,
K₂CO₃: potassium carbonate, anhydrous, average particle size 32.6 μm
NMP: N-methylpyrrolidone, anhydrous

The viscosity number VN of the sulfonated polyarylenesulfone polymer (sP) was measured according to DIN ISO 1628-1 in a 0.5% by weight NMP solution.

The incorporation ratio (the incorporation rate) of the sDCDPS was determined by 1H-NMR in CDCl₃.

The molecular weight distribution of the sulfonated polyarylenesulfone polymer (comparative examples C1, C2, C3, C4, C7, C8, C9 and C10) having a monomodal molecular weight distribution, and the sulfonated polyarylenesulfone polymer (sP) having a bimodal molecular weight distribution (examples 5 and 6) was determined by GPC using DMAc as solvent and narrowly distributed PMMA as described above.

In case of the comparative examples the precipitated sulfonated polyarylenesulfone polymers were dissolved in NMP at the same concentration as the corresponding solutions obtained in the inventive examples (20 wt. %). From this solution an appropriate quantity was dissolved in DMAc to a polymer concentration of 4 mg/ml. 100 μl of this solution was then injected to the GPC-system.

The isolation of the sulfonated polyarylenesulfone polymer having a monomodal molecular weight distribution was carried out, by precipitating a NMP solution of the sulfonated polyarylenesulfone polymer (sP) into isopropanol at room temperature. The drop height is 0.5 m. The throughput was about 2.5 l per hour. The obtained precipitate was then extracted with water (water throughput 160 l/h) at 85° C. for twenty hours. The material was then dried at a temperature below the glass transition temperature T_{g} to a residual moisture content of less than 2% by weight.

The filtration of the product mixture was done in a heated metal pressure filter using a filter with a 5 μm pore size and 3 bar N₂-pressure. The filter was heated to 60° C. to reduce the viscosity of the reaction mixture.

The yield of the sulfonated polyarylenesulfone polymers was determined gravimetrically.

### Comparative Example 1; Sulfonated Polyarylenesulfone Polymer having a Monomodal Molecular Weight Distribution

In a 4 liter glass reactor fitted with a thermometer, a gas inlet tube and a Dean-Stark-trap, 384.81 g (1.34 mol) of DCDPS, 343.84 g (0.70 mol) of sDCDPS, 372.42 g (2.00 mol) BP and 400.81 g (2.90 mol) of potassium carbonate with a volume average particle size of 32.6 μm were suspended in 1250 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation, losses in NMP were replenished.

After a reaction time of 8 hours, the reaction was stopped by the addition of 1750 ml NMP and cooling down to room temperature (within one hour). The potassium chloride formed in the reaction was removed by filtration. The obtained polymer solution was precipitated in isopropanol, the resulting polymer precipitate was separated and then extracted with hot water (85° C.) for 20 h. Then the precipitate was dried at 120° C. for 24 h at reduced pressure (<100 mbar).

### Comparative Example 2; Sulfonated Polyarylenesulfone Polymer having a Monomodal Molecular Weight Distribution

In a 4-liter glass reactor fitted with a thermometer, a gas inlet tube and a Dean-Stark-trap, 370.45 g (1.29 mol) of DCDPS, 368.40 g (0.75 mol) of sDCDPS, 372.42 g (2.00 mol) BP and 407.72 g (2.95 mol) of potassium carbonate with a volume average particle size of 32.6 μm were suspended in 1250 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation, losses in NMP were replenished.

After a reaction time of 8 hours, the reaction was stopped by the addition of 1750 ml NMP and cooling down to room temperature (within one hour). The potassium chloride formed in the reaction was removed by filtration. The obtained polymer solution was precipitated in isopropanol, the resulting polymer precipitate was separated and then extracted with hot water (85° C.) for 20 h. Then the precipitate was dried at 120° C. for 24 h at reduced pressure (<100 mbar).

### Comparative Example 3; Sulfonated Polyarylenesulfone Polymer having a Monomodal Molecular Weight Distribution

In a 4 liter glass reactor fitted with a thermometer, a gas inlet tube and a Dean-Stark-trap, 364.69 g (1.27 mol) of DCDPS, 378.26 g (0.77 mol) of sDCDPS, 372.42 g (2.00 mol) BP and 414.63 g (3.00 mol) of potassium carbonate with a volume average particle size of 32.6 μm were suspended in 1250 ml NMP in a nitrogen atmosphere. The mixture was heated to 190° C. within one hour. In the following, the reaction time shall be understood to be the time during which the reaction mixture was maintained at 190° C.

The water that was formed in the reaction was continuously removed by distillation, losses in NMP were replenished.

After a reaction time of 8 hours, the reaction was stopped by the addition of 1750 ml NMP and cooling down to room temperature (within one hour). The potassium chloride formed in the reaction was removed by filtration. The obtained polymer solution was precipitated in isopropanol, the resulting polymer precipitate was separated and then extracted with hot water (85° C.) for 20 h. Then the precipitate was dried at 120° C. for 24 h at reduced pressure (<100 mbar).

### Comparative Example 4; sulfonated Polyarylenesulfone Polymer having a Monomodal Molecular Weight Distribution

In a 4-liter glass reactor fitted with a thermometer, a gas inlet tube and a Dean-Stark-trap, 356.07 g (1.24 mol) of DCDPS, 393.00 g (0.80 mol) of sDCDPS, 372.42 g (2.00 mol) BP and 421.54 g (3.05 mol) of potassium carbonate with a volume average particle size of 32.6 μm were suspended in 1250 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation, losses in NMP were replenished.

After a reaction time of 8 hours, the reaction was stopped by the addition of 1750 ml NMP and cooling down to room temperature (within one hour). The potassium chloride formed in the reaction was removed by filtration. The obtained polymer solution was precipitated in isopropanol, the resulting polymer precipitate was separated and then extracted with hot water (85° C.) for 20 h. Then the precipitate was dried at 120° C. for 24 h at reduced pressure (<100 mbar).

### Example 5: Sulfonated Polyarylenesulfone Polymer (sP) having a Bimodal Molecular Weight Distribution

In a 4 liter glass reactor fitted with a thermometer, a gas inlet tube and a Dean-Starktrap, 384.81 g (1.34 mol) of DCDPS, 343.84 g (0.70 mol) of sDCDPS, 372.42 g (2.00 mol) BP and 400.81 g (2.90 mol) of potassium carbonate with a volume average particle size of 32.6 μm were suspended in 1250 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation, losses in NMP were replenished.

After a reaction time of 8 hours, the reaction was stopped by the addition of 1750 ml NMP and cooling down to room temperature (within one hour). The potassium chloride formed in the reaction was removed by filtration. The obtained polymer solution was used for membrane preparation. The polymer content of this solution was 23.9 wt. %.

### Example 6; Sulfonated Polyarylenesulfone Polymer (sP) having a Bimodal Molecular Weight Distribution

In a 4 liter glass reactor fitted with a thermometer, a gas inlet tube and a Dean-Starktrap, 370.45 g (1.29 mol) of DCDPS, 368.40 g (0.75 mol) of sDCDPS, 372.42 g (2.00mol) BP and 407.72 g (2.95 mol) of potassium carbonate with a volume average particle size of 32.6 μm were suspended in 1250 ml NMP in a nitrogen atmosphere. The mixture was heated to 190° C. within one hour. In the following, the reaction time shall be understood to be the time during which the reaction mixture was maintained at 190° C.

The water that was formed in the reaction was continuously removed by distillation, losses in NMP were replenished.

After a reaction time of 8 hours, the reaction was stopped by the addition of 1750 ml NMP and cooling down to room temperature (within one hour). The potassium chloride formed in the reaction was removed by filtration. The obtained polymer solution was used for membrane preparation. The polymer content of this solution was 24.0 wt. %.

### Comparative Examples 7, 8, 9 and 10: Sulfonated Polymers having Monomodal Molecular Weight Distributions

Small portions of the polymer solution obtained in example 5 were precipitated in water (comparative example C7), ethanol (comparative example C8), methanol (comparative example C9) and water/ethanol 1/1 (by vol) (comparative example C10). The obtained polymers were extracted with hot water for 20 h and then dried at 120° C. and then dried at 120° for 24 h under reduced pressure (<100 mbar).

To prepare the membranes, solutions of the separated polymers from examples C1, C2, C3, C4, C7, C8, C9 and C10 were prepared using a polymer content of 17.5 wt. %. The solutions of examples 5 and 6 were diluted with NMP to achieve a polymer content of 17.5 wt. %. Membranes from these solutions were prepared by casting the solutions with a doctor blade at a speed of 5 mm/s at a temperature of 60° C. onto a glass plate. The glass plate was transferred into a vacuum oven and the temperature was gradually increased to 100° C. and kept there for 12 h. After cooling to room temperature, the plates were put into a water bath, which led to a detachment of the membrane from the glass plate. The wet membrane was then fixed and dried in the vacuum for 12 h at 120° C.

The membranes prepared as described were cut into the required size (i.e. 5×5 cm). For activation the membranes were immersed into 0.5M H²SO₄ at 80° C. for 2 h. Subsequently the membranes were immersed into DI water (MiliQ 18.2 MOhm) at 80° C. for another 2 h and finally stored in a fresh batch of DI water at room temperature. To determine the conductivity, the membranes were sandwiched into a purpose made teflon cell, equipped with two rectangular gold electrodes (0.25 cm²). A constant pressure was achieved via adjusting the torque of the 4 screws to 4 Nm.

TABLE 1

| | C1 | C2 | C3 | C4 | 5 | 6 | C7 | C8 | C9 | C10 |
|---|---|---|---|---|---|---|---|---|---|---|
| Condensation | 8 | 8 | 8 | 8 | 8 | 8 | 8 | 8 | 8 | 8 |
| time [h] | | | | | | | | | | |
| M_{W} [g/mol] | 34500 | 34400 | 34100 | 33900 | 32800 | 31900 | 34000 | 34300 | 34200 | 34200 |
| Mₙ [g/mol] | 16200 | 16100 | 16000 | 15800 | 12900 | 12700 | 15400 | 15700 | 15600 | 15500 |
| V.N. [ml/g] | 67.2 | 66.0 | 67.1 | 65.9 | n.d | n.d. | 66.3 | 66.6 | 66.4 | 66.3 |
| sDCDPS-cont. | 32.5 | 33.2 | 34.9 | 36.0 | 34.1 | 35.8 | 32.6 | 32.9 | 32.7 | 32.8 |
| in polymer/ | | | | | | | | | | |
| film [mol %] | | | | | | | | | | |
| molecular | mono | mono | mono | mono | bi | bi | mono | mono | mono | mono |
| weight | | | | | | | | | | |
| distribution | | | | | | | | | | |
| conductivity | 10.0 | 10.2 | 10.7 | 11.3 | 13.6 | 14.0 | 10.1 | 10.2 | 10.1 | 10.2 |
| [mS/cm] | | | | | | | | | | |

The membranes (M) having a bimodal molecular weight distribution show higher conductivity.

1.-16. (canceled)

17. Sulfonated polyarylenesulfone polymer (sP) having an at least bimodal molecular weight distribution with at least one first peak (P1) and at least one second peak (P2), wherein the maximum of the first peak (P1) has a relative molecular mass in the range of 800 to 5 000 g/mol and the maximum of the second peak (P2) has a relative molecular mass in the range of 8 000 to 300 000 g/mol, wherein the relative molecular mass is determined by gel permeation chromatography using dimethylacetamide as solvent and narrowly distributed poly (methyl methacrylate) as standard, wherein the sulfonated polyarylenesulfone polymer (sP) is prepared by a process comprising
step i) converting a reaction mixture (R_{G}) comprising as components
(A) an aromatic dihalogensulfone component comprising
at least one sulfonated aromatic dihalogensulfone (component (A1)),
and at least one non sulfonated aromatic dihalogensulfone (component (A2)),
(B) at least one aromatic dihydroxy compound,
(C) at least on carbonate compound, and
(D) at least one aprotic polar solvent,
wherein after step i) a product mixture (P_{G}) is obtained comprising the sulfonated polyarylenesulfone polymer (sP), the at least one aprotic polar solvent and at least one inorganic halide compound, and wherein the process further comprises the steps of
ii) separating the at least one inorganic halide from the product mixture (P_{G}) to obtain a solution(S) comprising the sulfonated polyarylenesulfone polymer (sP) and the at least one aprotic polar solvent, and
iii) separating the at least one aprotic polar solvent from the solution(S) by evaporation to obtain the sulfonated polyarylenesulfone polymer (sP).

18. Sulfonated polyarylenesulfone polymer (sP) according to claim 17, wherein the maximum of the first peak (P1) shows a first intensity (I1) and the maximum of the second peak (P2) shows a second intensity (I2), wherein the ratio of the first intensity (I1) to the second intensity (I2) is in the range of 1:10 to 1:1000.

19. Sulfonated polyarylenesulfone polymer (sP) according to claim 17, wherein the sulfonated polyarylenesulfone polymer (sP) has a weight average molecular weight (M_{W}) in the range of 20 000 to 250 000 g/mol, wherein the weight average molecular weight (M_{W}) is determined by gel permeation chromatography using dimethylacetamide as solvent and narrowly distributed poly (methyl methacrylate) as standard.

20. Sulfonated polyarylenesulfone polymer (sP) according to claim 17, wherein the sulfonated polyarylenesulfone polymer (sP) comprises from 15 to 80 mol-% of sulfonated recurring units comprising at least one —SO₃X³ group, based on the total amount of the sulfontated polyarylenesulfone polymer (sP), wherein X³ is hydrogen or one cation equivalent.

21. The sulfonated polyarylenesulfone polymer (sP) according to claim 17, wherein the sulfonated polyarylenesulfone polymer (sP) comprises sulfonated recurring units of the general formula (I): 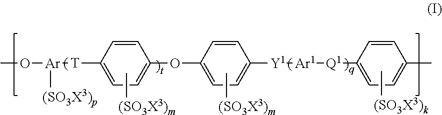
where
t and q: are each independently 0, 1, 2 or 3,
Q¹, T and Y¹: are each independently a chemical bond or selected from —O—, —S—, —SO₂—, —S(═O)—, —C(═O)—, —N═N—, and —CR^{a}R^{b}—,
wherein R^{a} and R^{b} are each independently a hydrogen atom or a C₁-C₁₂-alkyl, C₁-C₁₂-alkoxy or C₆-C₁₈-aryl group, and wherein at least one of Q, T and Y is —SO₂—,
Ar and Ar¹: are each independently C₆-C₁₈ aryl, wherein said C₆-C₁₈ aryl is unsubstituted or substituted with at least one substituent selected from C₁-C₁₂ alkyl, C₁-C₁₂ alkoxy, C₆-C₁₈ aryl, halogen and —SO₃X,
p, m, n, and k: are each independently 0, 1, 2, 3 or 4, with the proviso that the sum total of p, m, n and k is not less than 1, and
X³: is hydrogen or one cation equivalent.

22. A process for the preparation of a sulfonated polyarylenesulfone polymer (sP) according to claim 17 comprising the step i) of converting a reaction mixture (R_{G}) comprising as components
(A) an aromatic dihalogensulfone component comprising at least one sulfonated aromatic dihalogensulfone (component (A1)), and at least one non sulfonated aromatic dihalogensulfone (component (A2)),
(B) at least one aromatic dihydroxy compound, and
(C) at least on carbonate compound,
wherein the reaction mixture (R_{G})), moreover, comprises at least one aprotic polar solvent (component (D)) and wherein after step i) a product mixture (P_{G}) is obtained comprising the sulfonated polyarylenesulfone polymer (sP), the at least one aprotic polar solvent and at least one inorganic halide compound, and wherein the process moreover comprises the steps of
ii) separating the at least one inorganic halide from the product mixture (P_{G}) to obtain a solution(S) comprising the sulfonated polyarylenesulfone polymer (sP) and the at least one aprotic polar solvent, and
iii) separating the at least one aprotic polar solvent from the solution(S) by evaporation to obtain the sulfonated polyarylenesulfone polymer (sP).

23. The process according to claim 22 comprising the step
i) converting a reaction mixture (R_{G}) comprising
X mol of an aromatic dihalogensulfone component (component (A)) comprising, based on the total molar amount of the aromatic dihalogensulfone component (component A)) in the reaction mixture (R_{G}),
X¹ mol.-% of at least one sulfonated aromatic dihalogensulfone (component (A1)), and
X² mol.-% of at least one non sulfonated aromatic dihalogensulfone (component (A2)),
wherein X¹ is in the range of 15 to 80 and X² is in the range of 20 to 85,
Y mol of at least one aromatic dihydroxy compound (component (B))
Z mol of at least one carbonate compound (component (C)),
wherein
the ratio of X to Y is in the range of 0.95 to 1.05,
and wherein
Z is in the range of P to Q,
wherein P is calculated according to the following equation:
$$P = Y * ( 1.05 + {X}^{1} / 100 * 1.05 ) ,$$
and wherein Q is calculated according to the following equation:
$$Q = Y * ( 1.05 + {X}^{1} / 100 * 1.4 ) .$$

24. The process according to claim 22, wherein component (A1) comprises not less than 80 wt % of at least one compound selected from the group consisting of 4,4′-dichlorodiphenylsulfone-3,3′-disulfonic acid, 4,4′-dichloro-diphenylsulfone-3,3′-disulfonic acid disodium salt, 4,4′-dichlorodiphenylsulfone-3,3′-disulfonic acid dipotassium salt, 4,4′-difluorodiphenylsulfone-3,3′-disulfonic acid, 4,4′-difluorodiphenylsulfone-3,3′-disulfonic acid disodium salt and 4,4′-difluorodiphenylsulfone-3,3′-disulfonic acid dipotassium salt based on the overall weight of component (A1) in reaction mixture (R_{G}).

25. The process according to claim 22, wherein component (A2) comprises not less than 80wt % of at least one aromatic dihalogensulfone selected from the group consisting of 4,4′-dichlorodiphenylsulfone and 4,4′-difluorodiphenylsulfone, based on the overall weight of component (A2) in reaction mixture (R_{G}).

26. The process according to claim 22, wherein component (B) comprises not less than 80 wt % 4,4′-dihydroxybiphenyl, based on the overall weight of component (B) in reaction mixture (R_{G}).

27. A method comparing preparing a membrane utilizing the sulfonated polyarylenesulfone polymer (sP) according to claim 17.

28. Membrane (M) comprising the sulfonated polyarylenesulfone polymer (sP) according to claim 17.

29. A process for the preparation of a membrane (M) comprising the sulfonated polyarylenesulfone polymer (sP) according to claim 17 comprising the steps
ii-1) providing the solution (S) obtained in step ii) comprising the sulfonated polyarylenesulfone polymer (sP) and the at least on aprotic polar solvent, and
iii-1) separating the at least one aprotic polar solvent from the solution(S) to obtain the membrane (M).

30. Membrane (M) obtained by the process according to claim 29.
